(19) United States
(12) Patent Application Publication
(10) Pub. No.: US 2009/0088503 A1
(43) Pub. Date: Apr. 2, 2009

(54) Flame-Retardant Polyester Resin Composition

(75) Inventors: Kazuyuki Takagi, Osaka (JP); Noriyuki Suzuki, Hyogo (JP)

Correspondence Address: HAMRE, SCHUMANN, MUELLER & LARSON, P.C., P.O. BOX 2902, MINNEAPOLIS, MN, 55402-0902, US

(73) Assignee: KANEKA CORPORATION, Osaka-shi, Osaka (JP)

(21) Appl. No.: 11/992,553

(22) PCT Filed: Sep. 25, 2006
(86) PCT No.: PCT/JP2006/318937

§ 371 Date: Mar. 25, 2008

(30) Foreign Application Priority Data
Sep. 30, 2005 (JP) 2005-289252

(51) Int. Cl. C08K 5/53

(52) U.S. Cl. 524/117

(57) ABSTRACT

The present invention is intended to provide a non-halogen flame-retardant polyester resin composition that has a high level of low warping properties and is capable of providing a molded product free from sticky residue in which the bleed-out of the flame retardant is suppressed even when the molded product is exposed to a high temperature environment. The flame-retardant polyester resin composition, having a high level of low warping properties and capable of providing a molded product free from sticky residue in which the bleed-out of the flame retardant is suppressed even when the molded product is exposed to a high temperature environment, can be obtained by incorporating an organic phosphorus-based flame retardant represented by the following general formula (1) and an amorphous resin at a specific ratio relative to a thermoplastic polyester resin.

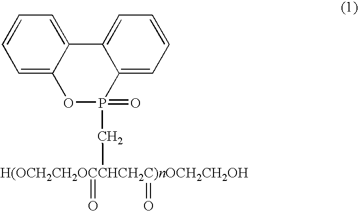

where n is an integer from 2 to 15.

### TECHNICAL FIELD

The present invention relates to flame-retardant polyester resin that does not contain a bromine-based or chlorine-based flame retardant or an antimony compound, and has excellent low warping properties, bleed-out resistance and flame retardancy.

### BACKGROUND ART

Thermoplastic polyester resin, as typified by polyalkylene terephthalate and the like, is used widely in electric and electronic components, automotive parts, and the like, due to its excellent properties. In recent years, in many cases, demand is growing for higher flame retardancy particularly in electric appliances, electric components and OA (office automation) equipments to secure safety against fire. For this reason, the mixing of various flame retardants has been studied.

To impart flame retardancy to thermoplastic polyester resin, a halogen-based flame retardant usually is used as a flame retardant. The combined use of the flame retardant with a flame retardant aid such as antimony trioxide as appropriate provides a resin composition having a high flame retardant effect, an excellent mechanical strength, heat resistance, and the like. However, restrictions on halogen-based flame retardants are about to be imposed, and in view of this, studies of non-halogenated flame retardants have been carried out.

A technique to provide a resin composition that is composed of an organic phosphorus-based flame retardant and a thermoplastic polyester resin having the same structure as that of the present application has been disclosed (Patent Document 1). This patent discloses that a flame retardancy of V-1 to V-0 according to UL94 standard can be achieved for a 3.2 mm thick compression molded product produced by using a polybutylene terephthalate resin.

However, in recent years, particularly electric appliances, electric components and OA equipment are required to have flame retardancy, and at the same time, the dimensional characteristics of the products, particularly low warping properties and the suppression of bleed-out of flame retardant from the products when used at high temperatures, are strongly required. The invention described in Patent Document 1 has not been able to achieve these requirements.

Patent Document 1: JP 53 (1978)-128195 A

### DISCLOSURE OF INVENTION

### Problem to be Solved by the Invention

It is an object of the present invention to provide a flame retardant polyester-based resin composition that has excellent low warping properties and provides improved suppression of the bleed-out of the flame retardant although it is a polyester-based resin composition that is a crystalline material.

### Means for Solving Problem

The present inventors conducted in-depth studies to achieve the above object, and have accomplished a flame-retardant polyester resin composition having excellent low warping properties and the effect of suppressing the bleed-out of the flame retardant by allowing an organic phosphorus-based flame retardant (B) having a specific structure and an amorphous resin (C) to be contained at a specific ratio relative to a thermoplastic polyester resin (A). In other words, the present invention relates to a composition and a resin molded product described below.

(1) A flame-retardant polyester resin composition containing 10 to 80 parts by weight of an organic phosphorus-based flame retardant (B) represented by the following general formula (1) and 1 to 30 parts by weight of an amorphous resin (C) relative to 100 parts by weight of a thermoplastic polyester resin (A):

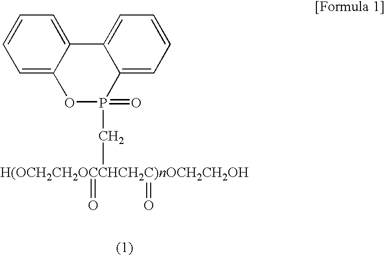

where n is an integer from 2 to 15.

(2) The flame-retardant polyester resin composition according to (1), wherein the amount of initial warping of a disk-shaped molded product (diameter 100 mmφ×thick 1.6 mm) is 5 mm or less.

(3) The flame-retardant polyester resin composition according to (1) or (2), wherein the thermoplastic polyester resin (A) is polyalkylene terephthalate resin.

(4) The flame-retardant polyester resin composition according to (3), wherein the polyalkylene terephthalate resin is polyethylene terephthalate resin.

(5) A resin molded product that is entirely or partially formed of the flame-retardant polyester resin composition according to any one of (1) to (4).

### EFFECTS OF THE INVENTION

The flame-retardant polyester resin composition according to the present invention has excellent low warping properties and provides improved suppression of the bleed-out of the flame retardant although it is a polyester-based resin composition that is a crystalline material. Thus, it is suitable for use as a molding material for electric appliances, electric components, OA equipment and the like, and is useful in industrial applications.

### BEST MODE FOR CARRYING OUT THE INVENTION

The thermoplastic polyester resin (A) used in the present invention is a saturated polyester resin obtained by using divalent acid, such as terephthalic acid, or a derivative thereof having ester-forming capability as an acid component, and a glycol having 2 to 10 carbon atoms, other divalent alcohol, or a derivative thereof having ester-forming capability as a glycol component. Among them, polyalkylene terephthalate resin is preferable because it has an excellent balance of processability, mechanical properties, electric properties and heat resistance, and the like. Specific examples of the polyalkylene terephthalate resin include polyethylene terephthalate resin, polybutylene terephthalate resin, and polyhexamethylene terephthalate resin. Among them, particularly, polyethylene terephthalate resin is preferable because it has excellent resistance to heat and chemicals.

The thermoplastic-polyester resin (A) used in the present invention may be a copolymer as appropriate. In this case, the copolymer component can be included preferably in a content of 20 or less parts by weight, and particularly preferably 10 or less parts by weight relative to 100 parts by weight of the thermoplastic polyester resin. As the copolymer component, a known acid component, alcohol component and/or phenol component, or a derivative thereof having ester-forming capability can be used.

The copolymerizable acid component can be, for example, a divalent or higher aromatic carboxylic acid having 8 to 22 carbon atoms, a divalent or higher aliphatic carboxylic acid having 4 to 12 carbon atoms, a divalent or higher alicyclic carboxylic acid having 8 to 15 carbon atoms, and derivatives thereof having ester-forming capability. Specific examples of the copolymerizable acid component can include terephthalic acid, isophthalic acid, naphthalene dicarboxylic acid, bis(p-carbodiphenyl)methane anthracene dicarboxylic acid, 4-4′-diphenyl carboxylic acid, 1,2-bis(phenoxy)ethane-4,4′-dicarboxylic acid, 5-sodium sulfoisophthalic acid, adipic acid, sebacic acid, azelaic acid, dodecanedioic acid, maleic acid, trimesic acid, trimellitic acid, pyromellitic acid, 1,3-cyclohexane dicarboxylic acid, 1,4-cyclohexane dicarboxylic acid, and derivatives thereof having ester-forming capability. They may be used alone or in combination of two or more. Among them, terephthalic acid, isophthalic acid and naphthalene dicarboxylic acid are preferable because the resins manufactured therefrom have excellent physical properties, ease of handling and ease of reactivity. The copolymerizable alcohol and/or phenol component can be, for example, a divalent or higher aliphatic alcohol having 2 to 15 carbon atoms, a divalent or higher alicyclic alcohol having 6 to 20 carbon atoms, a divalent or higher aromatic alcohol having 6 to 40 carbon atoms, or phenol, and derivatives thereof having ester-forming capability. Specific examples of the copolymerizable alcohol and/or phenol component can include: compounds such as ethylene glycol, propanediol, butanediol, hexanediol, decanediol, neopentyl glycol, cyclohexanedimethanol, cyclohexanediol, 2,2′-bis(4-hydroxyphenyl)propane, 2,2′-bis(4-hydroxycyclohexyl)propane, hydroquinone, glycerin and pentaerythritol; and derivatives thereof having ester-forming capability; and cyclic esters such as ε-caprolactone. Among them, ethylene glycol and butanediol are preferable because the resins manufactured therefrom have excellent physical properties, ease of handling and ease of reactivity.

Further, a polyalkylene glycol unit may be partially copolymerized. Examples of the polyoxyalkylene glycol can include polyethylene glycol, polypropylene glycol, polytetramethylene glycol, random or block copolymers thereof, modified polyoxyalkylene glycol such as an alkylene glycol (polyethylene glycol, polypropylene glycol, polytetramethylene glycol, and random or block copolymers thereof, etc) adduct of a bisphenol compound, and the like. Among them, a polyethylene glycol adduct of bisphenol A having a molecular weight of 500 to 2,000 is preferable because the thermal stability during copolymerization is good, and the heat resistance of a molded product obtained from the resin composition of the present invention will be less deteriorated.

These thermoplastic polyester resins (A) may be used alone or in combination of two or more.

The manufacturing method of the thermoplastic polyester resin (A) used in the present invention can be a known polymerization method such as melt polycondensation, solid-state polycondensation or solution polymerization, or the like. In order to improve the color tone of the resin in the polymerization process, one or two or more compounds such as phosphoric acid, phosphorous acid, hypophosphorous acid, monomethyl phosphate, dimethyl phosphate, trimethyl phosphate, methyldiethyl phosphate, triethyl phosphate, triisopropyl phosphate, tributyl phosphate, and triphenyl phosphate may be added.

Further, to increase the crystallinity of the obtained thermoplastic polyester resin, various known organic or inorganic crystal nucleators that usually are used for polymerization may be added alone or in combination of two or more.

It is preferable that the thermoplastic polyester resin (A) used in the present invention has an intrinsic viscosity (measured in a mixed solution of phenol and tetrachloroethane at a weight ratio of 1/1 at 25° C.) of 0.4 to 1.2 dl/g, and more preferably 0.6 to 1.0 dl/g. When the intrinsic viscosity of the thermoplastic polyester resin (A) is less than 0.4 dl/g, mechanical strength and impact resistance tend to be low. When the intrinsic viscosity of the thermoplastic polyester resin (A) exceeds 1.2 dl/g, the fluidity during molding tends to be low.

The organic phosphorus-based flame retardant (B) used in the present invention is represented by the following general formula (1):

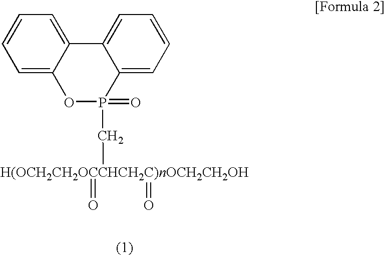

where n is an integer from 2 to 20. The integer n is 2 or larger, preferably 3 or larger, and particularly preferably 5 or larger. When n is less than 2, the crystallization of the polyester resin is inhibited, or the mechanical strength tends to be low. Conversely, an excessive increase of the molecular weight is likely to manufacture a harmful effect on dispersibihty and the like. For this reason, n is 20 or smaller, and preferably 15 or smaller, and particularly preferably 13 or smaller.

The manufacturing method of the organic phosphorus-based flame retardant (B) used in the present invention is not limited to a particular method, and can be a commonly-used polycondensation reaction. The organic phosphorus-based flame retardant (B) can be obtained by the following method, for example.

That is, in 9,10-dihydro-9-oxa-10-phosphaphenanthrene-10-oxide represented by the following structural formula (2):

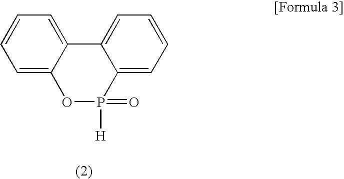

an equimolar amount of itaconic acid and ethylene glycol with at least twice as many moles as the itaconic acid are mixed. The resultant is heated at a temperature from 120 to 200° C. in a nitrogen gas atmosphere, and agitated to obtain a phosphorus-based flame retardant solution. To the obtained phosphorus-based flame retardant solution, antimony trioxide and zinc acetate are added, the temperature is maintained at 220° C. in vacuum under reduced pressure of 1 Torr or less, and a polycondensation reaction is performed while distilling ethylene glycol. About 5 hours later, when the amount of distilled ethylene glycol decreases significantly, the reaction was assumed to be terminated. The obtained organic phosphorus-based flame retardant (B) is a solid having a molecular weight of 4,000 to 12,000 and a phosphorus content of 8.3%. In the polycondensation reaction, a polyol other than ethylene glycol may coexist. Alternatively, polycarboxylic acid other than itaconic acid derivative may coexist. The polymers represented by the general formula (1) are construed to include polymers obtained through copolymerization of other polyol and polycarboxylic acid as above.

The content of the organic phosphorus-based flame retardant (B) in the flame-retardant polyester resin composition of the present invention preferably is 10 or more parts by weight, more preferably 20 or more parts by weight, and even more preferably 30 or more parts by weight relative to 100 parts by weight of the thermoplastic polyester resin. When the content of the organic phosphorus-based flame retardant (B) is 10 or less parts by weight, flame retardancy tends to be low. It is preferable that the content of the organic phosphorus-based flame retardant (B) is 80 or less parts by weight, and more preferably 70 or less parts by weight. When the content of the organic phosphorus-based flame retardant (B) exceeds 80 parts by weight, mechanical strength decreases, and moldability also tends to be deteriorated.

In the present invention, the incorporation of the amorphous resin (C) can impart low warping properties to the flame-retardant polyester resin composition and suppress the bleed-out of the flame retardant. As the amorphous resin (C) of the present invention, for example, polystyrene resin, polycarbonate resin, acrylic resin, polyphenylene ether (PPE) resin, or ABS resin can be used.

It is preferable that the amorphous resin of the present invention is not compatible with the polyester resin in order to impart low warping properties and to suppress the bleed-out. Particularly, polystyrene resin, polycarbonate resin, and polyphenylene ether resin are preferred. The dispersion of the amorphous resin that is not compatible with the polyester resin in the polyester resin imparts low warping properties to the resulting molded product. In addition, it is presumed that the bleed-out is suppressed because the amorphous resin prevents the spread of the flame retardant to the surface of the molded product. There is no particular limitation on the form of dispersion of the amorphous resin. Even when the amorphous resin is in the form of granules, the effect can be exerted. It is preferable that the amorphous resin is dispersed in a layered manner. In this case, the imparting of low warping properties and the suppression of bleed-out can be achieved more effectively.

The content of the amorphous resin (C) in the flame-retardant polyester resin composition of the present invention preferably is 1 or more part by weight, more preferably 5 or more parts by weight, and even more preferably 15 or more parts by weight relative to 100 parts by weight of the thermoplastic polyester resin. When the content of the amorphous resin (C) is less than 1 part by weight, low warping properties and the effect of suppressing the bleed-out of the flame retardant tend to be low. It is preferable that the content of the amorphous resin (C) is 30 or less parts by weight, and more preferably 20 or less parts by weight. When the upper limit value of the amorphous resin (C) content exceeds 30 parts by weight, heat resistance and flammability tend to be low.

The flame-retardant polyester resin composition of the present invention is a crystalline resin, but is capable of providing a molded product having excellent low warping properties, and a molded product in which the bleed-out of the flame retardant is suppressed even when exposed to high temperatures.

In the flame-retardant polyester resin composition of the present invention, it is preferable that the amount of initial warping of a disk-shaped molded product (diameter 100 mmφ×thickness 1.6 mm) obtained by an injection molding method is 5 mm or less, more preferably 3 mm or less, and even more preferably 2 mm or less. When the amount of initial warping of the molded product is greater than 5 mm, specified dimensional accuracy cannot be obtained in a molded product required to have dimensional accuracy, and troubles are likely to occur when mounting the molded product. The “amount of warping” used in the present invention means a value obtained by measuring, with the use of a height gage, the amount of rise of the diagonal edge of a disk-shaped molded product (diameter 100 mmφ×thickness 1.6 mm) placed on a surface plate with its edge being fixed.

Further, in the present invention, when the above molded product is heat treated in an atmosphere of 120° C. for one hour, it is preferable that the amount of warping of the molded product is 10 mm or less, and it is more preferable that sticky residue caused by the bleed-out of the flame retardant is not left in the heated molded product. More preferably, the amount of warping of the heated molded product is equal to or less than the amount of initial warping.

Where appropriate, an additive such as a nitrogen compound, glass fiber, inorganic filler, pigment, thermal stabilizer, antioxidant or lubricant can be added to the flame-retardant polyester resin composition of the present invention.

The manufacturing method of the flame-retardant polyester resin composition of the present invention is not limited a particular method, and for example, a method can be employed in which the polyester resin (A), the organic phosphorus-based flame retardant (B) and the amorphous resin (C) are melted and kneaded by using various commonly-used kneaders. The kneader can be, for example, a single screw extruder, twin screw extruder, or the like. Particularly, a twin screw extruder having a high kneading efficiency is preferable.

The flame-retardant polyester resin composition obtained by the present invention has a high level of warping properties even when molded into a very thin molded product, and the bleed-out of the flame retardant to the surface of the molded product is suppressed even when used in a high temperature environment. For this reason, the flame-retardant polyester resin composition of the present invention is suitable particularly for electric appliances, electric/electronic components used for OA apparatuses, housings, and the like, that are required to have a complicated shape.

### EXAMPLES

Hereinafter, the composition of the present invention will be described in further detail with reference to specific examples. However, it is to be understood that the present invention is not limited thereto. The following lists the resins and materials used in examples and comparative examples given below.

Thermoplastic polyester resin (A):

A resin obtained by drying polyethylene terephthalate (PET, available from Kanebo Gohsen, Ltd., EFG-70) having a inherent viscosity (measured in a mixed solution of phenol and tetrachloroethane at a weight ratio of 1/1 at 25° C., this applies hereinafter) of 0.65 dl/g at 140° C. for three hours.

Organic phosphorus-based flame retardant (B):

An organic phosphorus-based flame retardant manufactured in Manufacturing Example 1.

Amorphous resin (C):

(C1) Polystyrene resin (available from Toyo Styrene Co., Ltd., HRM24N);

(C2) Polycarbonate resin (PC, available from Idemitsu Petrochemical Co., Ltd., A1500); and

(C3) Polyphenylene ether resin (PPO, available from Mitsubishi Engineering Plastic Co., Ltd., YP100L)

Stabilizer:

Bisphenol A diglycidyl ether, butyl glycidyl ether (available from Asahi Denka Co. Ltd., EP-22);

Bis(2,6-di-t-butyl-4-methylphenyl)pentaerythritol diphosphite (available from Asahi Denka Co. Ltd., Adekastab PEP-36); and

Pentaerythritol tetrakis[3-(3,5-di-t-butyl-4-hydroxyphenyl)propionate] (available from Ciba Specialty Chemicals Inc., IRGANOX1010).

### Manufacturing Example 1

Into a vertical polymerizer equipped having a distillation tube, a rectification tube, a nitrogen inlet tube and an agitator, relative to 100 parts by weight of 9,10-dihydro-9-oxa-10-phosphaphenanthrene-10-oxide represented by the following structural formula (2):

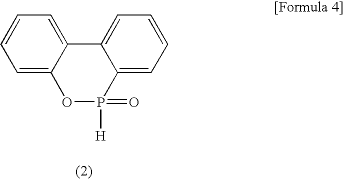

60 parts by weight of an equimolar amount of itaconic acid, and 160 parts by weight of ethylene glycol with at least twice as many moles as the itaconic acid were added. They were heated at a temperature from 120 to 200° C. in a nitrogen gas atmosphere by gradually increasing the temperature, and agitated for about 10 hours to obtain a phosphorus-based flame retardant solution. To the obtained phosphorus-based flame retardant solution, 0.1 parts by weight of antimony trioxide and 0.1 parts by weight of zinc acetate were added, the temperature was maintained at 220° C. under a vacuum of reduced pressure of 1 Torr or less, and a polycondensation reaction was performed while distilling ethylene glycol. About 5 hours later, when the amount of distilled ethylene glycol decreased significantly, the reaction was assumed to be terminated. The obtained organic phosphorus-based flame retardant (B) was a solid having a molecular weight of 7,000 and a phosphorus content of 8.3%.

In this specification, evaluation was performed by the following methods.

<Flame Retardancy>

Flammability was evaluated according to UL94 standard V-0 test by using a 3.2 mm thick bar-shaped test piece obtained from the composition.

<Low Warping Properties>

A disk-shaped molded product that had a size of diameter 100 mmφ×thickness 1.6 mm and was obtained from the composition was placed horizontally on a surface plate, and the edges were fixed. The amount of rise of the diagonal edge was measured by a height gage (available from Mitutoyo Corporation), and the resultant was referred to as the amount of initial warping. Further, the molded product after measurement was heated in an oven at 120° C. for one hour, was allowed to stand for 12 hours in an environment of 25° C.×50 Rh %, and then the amount of warping was measured in the same manner.

<Bleed-Out Evaluation>

Absorbent cotton was pressed against the molded product used in the low warping evaluation after heating at 120° C., the presence or absence of the absorbent cotton attached on the molded product was observed, and evaluation was made.

Good: no bleed-out of flame retardant and no absorbent cotton attached on the molded product were found.

Poor: the bleed-out of flame retardant and the absorbent cotton attached on the molded product were found.

### Examples 1 to 7

The materials (A) to (C) were dry mixed in advance according to the formulation (unit: part by weight) shown in Table 1. The mixture was supplied to a 44 mmφ co-rotating bent type twin screw extruder (available from Japan Steel Works, Ltd., TEX44) from the hopper inlet, and then melted and kneaded at a cylinder temperature set to 250 to 280° C. to obtain pellets.

The obtained pellets were dried at 140° C. for three hours, after which injection molding was performed by using an injection molding machine (clamping pressure: 80 tons) under conditions of a cylinder temperature of 280° C. to 250° C. and a mold temperature of 90° C., so as to obtain a disk-shaped molded product having a size: diameter 100 mmφ×thickness 1.6 mm, and a bar-shaped molded product having a size: 127 mm×12.7 mm×thickness 3.2 mm. Using the obtained test pieces, warping evaluation and flammability evaluation were performed according to the above-mentioned methods. The results of the evaluations for Examples 1 to 7 are shown in Table 1.

TABLE 1
Examples

| | | | Example | | | | | | |
|---|---|---|---|---|---|---|---|---|---|
| | | | 1 | 2 | 3 | 4 | 5 | 6 | 7 |
| Formulation | (A) Thermoplastic polyester | PET | 100 | 100 | 100 | 100 | 100 | 100 | 100 |
| (part) | (B) Organic phosphorus-based | | 10 | 80 | 40 | 30 | 30 | 60 | 20 |
| | flame retardant | | | | | | | | |
| | (C) Amorphous resin | Polystyrene | | 20 | 1 | | 5 | | |
| | | PC | 30 | | | 20 | | | 20 |
| | | PPO | | | | | 5 | 15 | |
| | Stabilizer | EP-22 | 1.5 | 1.5 | 1.5 | 1.5 | 1.5 | 1.5 | 1.5 |
| | | PEP-36 | 1.5 | 1.5 | 1.5 | 1.5 | 1.5 | 1.5 | 1.5 |
| | | IRGANOX10101 | 1.5 | 1.5 | 1.5 | 1.5 | 1.5 | 1.5 | 1.5 |
| Properties | UL94 flammability | 3.2 mm thick | V-0 | V-0 | V-0 | V-0 | V-0 | V-0 | V-0 |
| | Amount of warping | Initial | 2 | 5 | 3 | 2 | 3 | 2 | 3 |
| | | After heated at | 3 | 5 | 3 | 2 | 3 | 3 | 4 |
| | | 120° C. | | | | | | | |
| | Bleed-out evaluation | Judgment | Good | Good | Good | Good | Good | Good | Good |

### Comparative Examples 1 to 6

The materials (A) to (C) were mixed according to the formulation (unit: part by weight) shown in Table 2. The mixture was then formed into pellets, and injection molding was performed in the same manner as in Example to obtain test pieces. Then, the test pieces were subjected to the same evaluations as those described above. The results of the evaluations for Comparative Examples 1 to 6 are shown in Table 2.

TABLE 2
Comparative Examples

| | | | Example | | | | |
|---|---|---|---|---|---|---|---|
| | | | 1 | 2 | 3 | 4 | 5 |
| Formulation | Thermoplastic polyester (A) | PET | 100 | 100 | 100 | 100 | 100 |
| (part) | Organic phosphorus-based | | 5 | 80 | 90 | 20 | 30 |
| | flame retardant (B) | | | | | | |
| | Amorphous resin (C) | Polystyrene | | | | 35 | 40 |
| | | PC | | | 10 | | |
| | | PPO | 20 | | | | |
| | Stabilizer | EP-22 | 1.5 | 1.5 | 1.5 | 1.5 | 1.5 |
| | | PEP-36 | 1.5 | 1.5 | 1.5 | 1.5 | 1.5 |
| | | IRGANOX10101 | 1.5 | 1.5 | 1.5 | 1.5 | 1.5 |
| Properties | UL94 flammability | 3.2 mm thick | Not. V | V-0 | V-0 | V-2 | Not. V |
| | Amount of warping | Initial | 2 | 7 | 5 | 2 | 3 |
| | | After heated at | 3 | 8 | 6 | 2 | 3 |
| | | 120° C. | | | | | |
| | Bleed-out evaluation | Judgment | Good | Poor | Poor | Good | Good |

It can be seen from the comparison between the examples and the comparative examples that the flame-retardant polyester resin composition of the present invention obtained by specifying the mixture ratio of the organic phosphorus-based flame retardant (B) and the amorphous resin (C) relative to the thermoplastic polyester resin A) has excellent low warping properties and provides excellent suppression of bleed-out of the flame retardant.

### INDUSTRIAL APPLICABILITY

A molded product manufactured by using the flame-retardant polyester resin composition obtained according to the present invention has a high level of low warping properties even when the molded product has a very complicated shape, and the bleed-out of the flame retardant is suppressed even when the molded product is exposed to a high temperature environment, and thus sticky residue is not left. The molded product is suitable particularly for electric appliances, electric/electronic components used for OA apparatuses, housings, and the like, that are required to have a complicated shape and have the possibility of being exposed in a high temperature environment.

1. A flame-retardant polyester resin composition comprising 10 to 80 parts by weight of an organic phosphorus-based flame retardant (B) represented by the following general formula (1) and 1 to 30 parts by weight of an amorphous resin (C) relative to 100 parts by weight of a thermoplastic polyester resin (A): 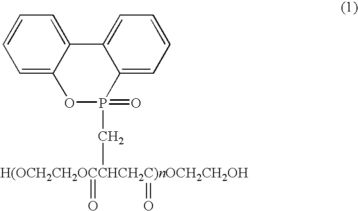
where n is an integer from 2 to 15.

2. The flame-retardant polyester resin composition according to claim 1, wherein the amount of initial warping of a disk-shaped molded product (diameter 100 mmφ×thick 1.6 mm) is 5 mm or less.

3. The flame-retardant polyester resin composition according to claim 1, wherein the thermoplastic polyester resin (A) is polyalkylene terephthalate resin.

4. The flame-retardant polyester resin composition according to claim 3, wherein the polyalkylene terephthalate resin is polyethylene terephthalate resin.

5. The flame-retardant polyester resin composition according to claim 1, wherein the organic phosphorus-based flame retardant (B) has a molecular weight ranging from 4,000 to 12,000, and is a solid.

6. The flame-retardant polyester resin composition according to claim 5, wherein the organic phosphorus-based flame retardant (B) is obtained by mixing, relative to 9,10-dihydro-9-oxa-10-phosphaphenanthrene-10-oxide, an equimolar amount of itaconic acid and ethylene glycol with at least twice as many moles as the itaconic acid, and by heating the mixture at 120 to 200° C. in a nitrogen gas atmosphere under agitation to obtain a phosphorus-based flame retardant solution, followed by a polycondensation reaction.

7. The flame-retardant polyester resin composition according to claim 1, wherein the amorphous resin (C) is at least one selected from the group consisting of polystyrene resin, polycarbonate resin, acrylic resin, polyphenylene ether (PPE) resin, and acrylonitrile-butadiene-styrene (ABS) resin.

8. The flame-retardant polyester resin composition according to claim 7, wherein the amorphous resin is not compatible with the thermoplastic polyester resin.

9. The flame-retardant polyester resin composition according to claim 7, wherein the amorphous resin is dispersed in the thermoplastic polyester resin in a layered manner.

10. A resin molded product comprising a flame-retardant polyester resin composition comprising 10 to 80 parts by weight of an organic phosphorus-based flame retardant (B) represented by the following general formula (1) and 1 to 30 parts by weight of an amorphous resin (C) relative to 100 parts by weight of a thermoplastic polyester resin (A): 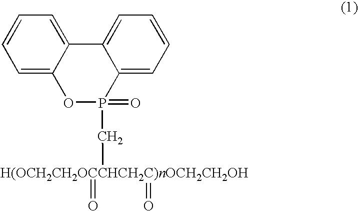
where n is an integer from 2 to 15.
